(19) United States
(12) Patent Application Publication
(10) Pub. No.: US 2026/0116707 A1
(43) Pub. Date: Apr. 30, 2026

(54) LIFT DEVICE WITH IMPLEMENT STABILIZATION

(71) Applicant: Oshkosh Corporation, Oshkosh, WI (US)

(72) Inventor: Gregory Brulo, Oshkosh, WI (US)

(21) Appl. No.: 19/086,628

(22) Filed: Mar. 21, 2025

Related U.S. Application Data
(60) Provisional application No. 63/712,624, filed on Oct. 28, 2024.

(51) Int. Cl. B66C 13/06; B66C 1/68; B66C 13/18; B66C 15/00; B66C 23/00; B66C 23/38; B66C 23/70; B66F 11/04

(52) U.S. Cl. CPC B66C 13/06; B66C 1/68; B66C 13/18; B66C 15/00; B66C 23/38; B66C 23/54; B66C 23/701; B66C 2700/0357; B66C 2700/082; B66C 2700/084; B66C 2700/087; B66F 11/046

(57) ABSTRACT

A lift device includes a chassis, an implement assembly including an implement actuator, and a lift assembly coupling the implement assembly to the chassis and configured to raise the implement assembly relative to the chassis. The lift device further includes at least one of a gyroscope assembly, a hydraulic stabilization system, or a first boom portion and a second boom portion. Rotation of a flywheel causes the gyroscope assembly to apply a force to the implement assembly to oppose movement of the implement assembly. Responsive to movement of the implement assembly when a valve is in a closed position, fluid flowing between the implement actuator and a fluid source is directed through an orifice via a second supply line, thereby restricting the flow of fluid and dampening the movement of the implement assembly.

### CROSS-REFERENCE TO RELATED PATENT APPLICATION

This application claims the benefit of and priority to U.S. Provisional Patent Application No. 63/712,624, filed Oct. 28, 2024, which is incorporated herein by reference in its entirety.

### BACKGROUND

The present disclosure relates generally to lift devices. More specifically, the present disclosure relates to stabilizing an implement of a lift device.

### SUMMARY

One embodiment relates to a lift device. The lift device includes a chassis, an implement assembly including an implement actuator, a lift assembly coupling the implement assembly to the chassis and configured to raise the implement assembly relative to the chassis, and at least one of a gyroscope assembly, a hydraulic stabilization system, or a first boom portion and a second boom portion. The gyroscope assembly is coupled with the implement assembly and configured to stabilize the implement assembly. The gyroscope assembly includes a housing and a flywheel rotatably coupled to the housing. Rotation of the flywheel causes the gyroscope assembly to apply a force to the implement assembly to oppose movement of the implement assembly. The hydraulic stabilization system is coupled with the implement assembly and configured to stabilize the implement assembly. The hydraulic stabilization system includes a fluid source fluidly coupled with the implement actuator, a valve assembly fluidly coupled between the fluid source and the implement actuator along a first supply line, the valve assembly actuatable between (i) an open position to permit a flow of fluid between the fluid source and the implement actuator via the first supply line and (ii) a closed position to inhibit the flow of fluid between the fluid source and the implement actuator via the first supply line, and an orifice fluidly coupled between the fluid source and the implement actuator along a second supply line, the orifice restricting the flow of fluid therethrough. Responsive to movement of the implement assembly when the valve is in the closed position, fluid flowing between the implement actuator and the fluid source is directed through the orifice via the second supply line, thereby restricting the flow of fluid and damping the movement of the implement assembly. A first material or a first thickness of the first boom portion is different than a second material or a second thickness of the second boom portion, respectively, such that the first boom portion is capable of supporting a load greater than a load capable of being supported by the second boom portion.

Another exemplary embodiment relates to lift device. The lift device includes a chassis, an implement assembly, a lift assembly coupling the implement assembly to the chassis and configured to raise the implement assembly relative to the chassis, and a gyroscope assembly coupled with the implement assembly and configured to stabilize the implement assembly. The gyroscope assembly includes a housing defining an interior chamber, a flywheel rotatably coupled to the housing within the interior chamber, and at least one frame coupling the housing with the implement assembly. Rotation of the flywheel causes the gyroscope assembly to apply a force to the implement assembly to oppose movement of the implement assembly.

Still another exemplary embodiment relates to lift device. The lift device includes a chassis, an implement assembly, a lift assembly coupling the implement assembly to the chassis and configured to raise the implement assembly relative to the chassis, and a gyroscope assembly coupled with and centered along the implement assembly and configured to stabilize the implement assembly. The gyroscope assembly includes a housing, a flywheel rotatably coupled to the housing, and a clutch that is transitionable between an engaged state and a disengaged state. The housing is coupled with at least one of a frame coupled with the implement assembly or the implement assembly. Rotation of the flywheel causes the gyroscope assembly to apply a force to the implement assembly to oppose movement of the implement assembly. In the engaged state, the clutch couples the housing with at least one of the frame or the implement assembly such that the implement assembly experiences the force from the gyroscope assembly to oppose movement of the implement assembly. In the disengaged state, the clutch decouples the housing from the frame and the implement assembly such that the housing can rotate relative to the frame and the implement assembly and the implement assembly does not experience the force from the gyroscope assembly.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a lift device, according to an exemplary embodiment.

FIG. 2 is a perspective view of the lift device of FIG. 1 configured as a boom lift, according to an exemplary embodiment.

FIG. 3 is a perspective view of the lift device of FIG. 1 including a gyroscope assembly coupled to a partially transparent implement assembly, according to an exemplary embodiment.

FIG. 4 is a perspective view of the gyroscope assembly of FIG. 3 with a housing and a frame shown as partially transparent, according to an exemplary embodiment.

FIG. 5 is a cross-sectional view of the gyroscope assembly of FIG. 3, according to an exemplary embodiment.

FIG. 6 is a perspective view of the lift device of FIG. 1 including three gyroscope assemblies of FIG. 3 having various orientations, according to an exemplary embodiment.

FIG. 7 is a block diagram of a hydraulic stabilization system, according to an exemplary embodiment.

FIG. 8 is a side view a boom section of the lift device of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, a lift device includes a chassis, an implement assembly including an implement actuator, and a lift assembly coupling the implement assembly to the chassis and configured to raise the implement assembly relative to the chassis. The implement assembly may include a tool, a manipulator, a platform, or the like to perform a task (e.g., moving material, manipulating material by welding, cutting, etc., supporting one or more operators, etc.) associated with an operation of the lift device. Operation of the implement assembly causes a movement (e.g., oscillations) experienced by the implement assembly and/or by one or more operators supported thereby. To facilitate stabilizing the implement assembly, the lift device may include a gyroscope assembly or a hydraulic stabilization system, or the lift assembly of the lift device may include at least one boom section defining a first boom portion and a second boom portion having different properties (e.g., materials, thicknesses, etc.).

The gyroscope assembly may be coupled with the implement assembly. The gyroscope assembly may include a housing defining an interior chamber, a flywheel rotatably coupled to the housing within the interior chamber, and a frame coupling the housing with the implement assembly. During operation of the gyroscope assembly, responsive to movement of the implement assembly, the flywheel precesses (e.g., an axis of rotation tilts). The rotation of the flywheel causes the gyroscope assembly to apply a force to the implement assembly to oppose movement of the implement assembly, thereby stabilizing the implement assembly. The gyroscope assembly may include a clutch configured to selectively engage or disengage a frame of the gyroscope assembly with the implement assembly. When the clutch is engaged (e.g., the frame and implement assembly are engaged) the force generated by the flywheel responsive to the movement of the implement assembly can be transferred from a housing of the gyroscope assembly to the frame and the implement assembly such that the implement assembly experiences the force the opposes the movement of the implement assembly.

The hydraulic stabilization system may be coupled with the implement assembly. The hydraulic stabilization system may include a fluid source (e.g., a compressor, a pump, etc.) fluidly coupled with the implement actuator, a valve assembly fluidly coupled between the fluid source and the implement actuator along a first supply line, and an orifice fluidly coupled between the fluid source and the implement actuator along a second supply line. The valve assembly may be actuatable between (i) an open position to permit a flow of fluid between the fluid source and the implement actuator and (ii) a closed position to inhibit the flow of fluid between the fluid source and the implement actuator. The orifice restricts the flow of fluid therethrough (e.g., reduces a flow rate of the fluid due to the orifice defining an inner diameter less than that of the second supply line). Responsive to movement of the implement assembly, the implement actuator supplies fluid therefrom to the fluid source such that, when the valve assembly is in the closed position, the flow of fluid is directed through the orifice via the second supply line such that movement of the implement assembly is dampened, thereby stabilizing the implement assembly.

The boom section may include a first boom portion having a first material or a first thickness that is different than a second material or a second thickness of a second boom portion, respectively. By way of example, the first material may be stronger (e.g., have a greater tensile strength, yield strength, Young's modulus, etc.) than the second material. By way of another example, the first thickness may be greater than the second thickness. In such examples, the boom section may gradually or linearly taper down from the first thickness to the second thickness and/or the boom section may step down (e.g., creating shoulders) from the first thickness to the second thickness. The first boom portion (e.g., a portion of the boom section coupled closer to a base of the life device) may be capable of supporting a load greater than a load capable of being supported by the second boom portion (e.g., a portion of the boom section opposite the first portion, a portion of the boom section configured to couple with the implement assembly, etc.).

### Lift Device

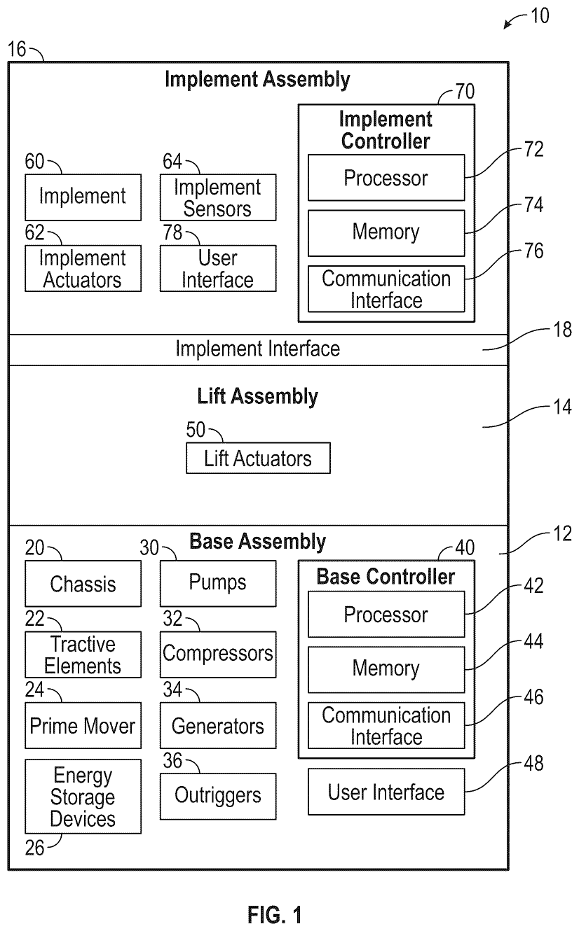

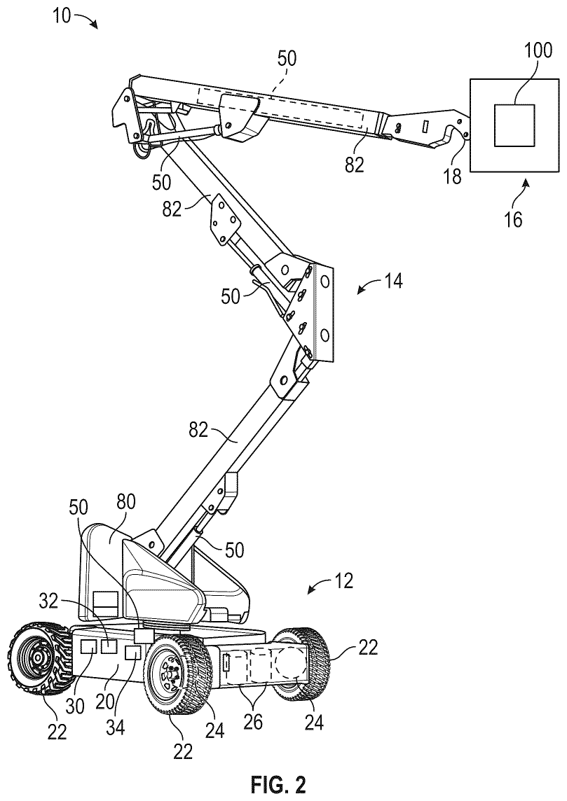

Referring to FIGS. 1 and 2, a vehicle, work machine, lifting apparatus, or lift device is shown as lift device 10 according to an exemplary embodiment. By way of example, the lift device may be or include a mobile elevating work platform (MEWP), a telehandler, a boom lift, a vertical lift, a scissor lift, a firetruck, or any other type of machine capable of moving (e.g., lifting) material or people to a desired position. The lift device 10 may be human operated, partially autonomous, or completely autonomous.

As shown, the lift device 10 includes a base assembly 12 (e.g., a base, a support assembly, a drivable support assembly, a support structure, a chassis, etc.), a lift assembly 14 (e.g., a boom, a boom lift assembly, a lifting apparatus, an articulated arm, a scissor lift, a ladder, a telescoping assembly, etc.), and an implement assembly 16 (e.g., a tool, a manipulator, a platform, etc.). A coupler or interface, shown as implement interface 18, couples the implement assembly 16 to the lift assembly 14.

The base assembly 12 is configured to support the other components of the lift device 10 and propel the lift device 10 on the ground. The lift assembly 14 is configured to move (e.g., lift, translate, pivot, rotate, etc.) the implement interface 18 and the corresponding implement assembly 16 relative to the base assembly 12. The implement assembly 16 is configured to perform one or more tasks (e.g., moving material, manipulating material by welding, cutting, etc., supporting one or more operators, etc.).

As shown in FIG. 1, the base assembly 12 includes a frame or chassis, shown as chassis 20, that supports the other components of the base assembly 12. A series of tractive elements (e.g., wheels, tracks, etc.), shown as tractive elements 22, are coupled to the chassis 20. The tractive elements 22 engage a support surface (e.g., the ground) to support the lift device 10. One or more actuators, shown as prime mover 24, are configured to drive the tractive elements 22 to steer and/or propel the lift device 10. By way of example, the prime mover 24 may be or include an electric motor and/or an internal combustion engine that receive stored energy and provide rotational mechanical energy to operate various functions of the lift device 10. The base assembly 12 further includes one or more energy storage devices 26 coupled to the chassis 20. The energy storage devices 26 may include batteries, capacitors, fuel tanks, fuel cells, and/or other energy storage devices. The energy storage devices 26 are configured to store energy (e.g., chemically) and provide the stored energy to the prime mover 24 and/or other components of the lift device 10.

Referring still to FIG. 1, the base assembly 12 includes one or more pumps 30, compressors 32, and/or generators 34 coupled to the chassis 20. The pumps 30 may receive rotational mechanical energy (e.g., from the prime mover 24) and provide a supply of pressurized liquid (e.g., hydraulic oil, water, etc.). The compressors 32 may receive rotational mechanical energy (e.g., from the prime mover 24) and provide a supply of pressurized gas (e.g., air, refrigerant, etc.). The generators 34 may receive rotational mechanical energy (e.g., from the prime mover 24) and provide a supply of electrical energy (e.g., to be stored in an energy storage device 26). The pressurized liquid, the pressurized gas, and/or the electrical energy may be supplied to various components of the lift device 10 to facilitate operation of the lift device 10.

The base assembly 12 further includes one or more deployable supports (e.g., outriggers, downriggers, etc.), shown as outriggers 36, coupled to the chassis 20. The outriggers 36 may be selectively repositionable between a stored position and a deployed position. In the stored position, the outriggers 36 are retracted toward the chassis 20 and away from a support surface (e.g., the ground). In the deployed position, the outriggers 36 extend outward and engage the support surface and support the base assembly 12. The outriggers 36 may be used to level the chassis 20 and/or increase the stability of the lift device 10 (e.g., when the lift assembly 14 is extended).

The base assembly 12 further includes a control circuit or processing circuit, shown as base controller 40, coupled to the chassis 20. The base controller 40 is operatively coupled to (e.g., in communication with) components of the base assembly 12 and the lift assembly 14. The base controller 40 may control operation of the components of the base assembly 12 and the lift assembly 14 directly. The base controller 40 may control operation of the implement assembly 16 indirectly (e.g., through the implement controller 70). Alternatively, the implement controller 70 may be omitted, and the base controller 40 may control operation of the entire lift device 10. The base controller 40 includes a processor 42 and a memory device, shown as memory 44. The memory 44 is configured to store instructions thereon that, when executed by the processor 42, cause the base controller 40 to perform the various functions described herein.

The base controller 40 further includes a network interface, shown as communication interface 46. The communication interface 46 is configured to send and receive information (e.g., data, commands, signals, etc.). The communication interface 46 may communicated through a wired connection (e.g., a CAN bus, an ethernet connection, etc.) and/or wirelessly (e.g., using Bluetooth, radio, Wi-Fi, cellular networks, etc.). The communication interface 46 may communicate with the other components of the lift device 10. The communication interface 46 may communicate with components outside of the lift device 10 (e.g., user devices such as smartphones or laptops, networks such as the Internet, servers, etc.).

The base assembly 12 further includes an input/output device, shown as user interface 48, coupled to the chassis 20 and operatively coupled to the base controller 40. The user interface 48 may be positioned to be accessible by a user positioned on the ground and/or on the base assembly 12. The user interface 48 may be configured to receive information (e.g., commands) from the user. By way of example, the user interface 48 may include touch screens, buttons, switches, knobs, or other input devices. The user interface 48 may be configured to provide information (e.g., status information) to the user. By way of example, the user interface 48 may include displays, lights, speakers, or other output devices.

The lift assembly 14 includes one or more actuators, shown as lift actuators 50. The lift actuators 50 are configured to apply mechanical energy (e.g., a force, a torque, etc.) to raise, lower, translate, or otherwise control the lift assembly 14 to move the implement interface 18. By way of example, lift actuators 50 may include hydraulic actuators (e.g., hydraulic motors, hydraulic cylinders, etc.), pneumatic actuators (e.g., pneumatic motors, pneumatic cylinders, etc.), electric actuators (e.g., electric motors, electric linear actuators, etc.), or other types of actuators. The lift actuators 50 may be powered by the pumps 30, the compressors 32, the generators 34, the energy storage devices 26, and/or other energy sources. Operation of the lift actuators 50 may be controlled by the base controller 40.

The implement interface 18 is configured to couple the implement assembly 16 to the lift assembly 14. In some embodiments, the implement interface 18 removably couples the implement assembly 16 to the lift assembly 14. In other embodiments, the implement interface 18 permanently couples the implement assembly 16 to the lift assembly 14. The implement interface 18 may fixedly couple the implement assembly 16 to a distal end portion of the lift assembly 14. The implement interface 18 may pass data (e.g., electrical signals), electrical energy, hydraulic fluid, compressed gas, or other signals between (a) the base assembly 12 and the lift assembly 14 and (b) the implement assembly 16 to power or control the implement assembly 16.

The implement assembly 16 includes a tool, manipulator, or platform, shown as implement 60. The implement 60 may be configured to perform a desired task. In some embodiments, the implement 60 includes a tool that facilitates moving an object. By way of example, the implement 60 may include robotic arms, lift forks, buckets, hooks, suction cups, claws, or other manipulators. In some embodiments, the implement 60 includes a tool that performs a task other than moving material. By way of example, the implement 60 may include pressure washers, spray nozzles, sand blasters, air guns, paint guns, tape guns, welders, lights, or other tools. In some embodiments, the implement 60 includes an inspection tool. By way of example, the implement 60 may include cameras, temperature sensors, multimeters, contact probes that measure the profile of a surface, or other inspection tools. In some embodiments, the implement 60 includes a work platform (e.g., a basket, an operator platform) that is configured to support one or more operators.

The implement assembly 16 further includes one or more actuators, shown as implement actuators 62, coupled to the implement 60. The implement actuators 62 are configured to reposition (e.g., translate, rotate, raise, lower, etc.) or otherwise move the implement 60 relative to the implement interface 18. By way of example, the implement actuators 62 may include hydraulic actuators, pneumatic actuators, electric actuators, or other types of actuators.

The implement assembly 16 further includes one or more sensors, shown as implement sensors 64. The implement sensors 64 may provide sensor data indicating the position of the implement 60 relative to other components of the lift device 10 (e.g., the implement interface 18) and/or the surrounding environment. By way of example, the implement sensors 64 may include LIDAR sensors, ultrasonic sensors, contact sensors (e.g., limit switches), potentiometers, optical encoders, or other types of sensors. The sensor data from the implement sensors 64 may be used to facilitate closed-loop control over the position of the implement 60.

The implement assembly 16 further includes a control circuit or processing circuit, shown as implement controller 70, coupled to the implement interface 18. The implement controller 70 is operatively coupled to (e.g., in communication with) with the implement 60, the implement actuators 62, and the implement sensors 65. The implement controller 70 may control operation of the components of the implement assembly 16 directly. The implement controller 70 may control operation of the base assembly 12 and the lift assembly 14 indirectly (e.g., through the base controller 40). The implement controller 70 includes a processor 72 and a memory device, shown as memory 74. The memory 74 is configured to store instructions thereon that, when executed by the processor 72, cause the implement controller 70 to perform the various functions described herein.

Referring specifically to FIG. 1, the implement controller 70 further includes a communication interface 76. The communication interface 76 may be substantially similar to the communication interface 46, except as otherwise specified herein. The communication interface 76 may communicate with the communication interface 46 of the base controller 40.

The implement assembly 16 further includes an input/output device, shown as user interface 78, coupled to the implement interface 18 and operatively coupled to the implement controller 70. The user interface 78 may be positioned to be accessible by a user positioned on the implement 60 (e.g., on a platform of the implement 60). The user interface 78 may perform similar functions to the user interface 48.

Referring to FIG. 2, the lift device 10 is shown implemented as a boom lift, according to an exemplary embodiment. As shown in FIG. 2, the lift assembly 14 of the lift device 10 includes a rotating portion, shown as turntable 80, and a series of movable portions or boom members, shown as boom sections 82. The turntable 80 is rotatably coupled to the chassis 20. A first lift actuator 50 (e.g., a turntable actuator) is configured to cause the turntable 80 to rotate relative to the chassis 20 about a substantially vertical axis. The boom sections 82 extend between the turntable 80 and the implement interface 18. A first boom section 82 is pivotally coupled to the turntable 80, and one of the lift actuators 50 causes the first boom section 82 to rotate relative to the turntable 80. A second boom section 82 is coupled to the implement interface 18. The other boom sections 82 extend between the first and second boom sections 82. The lift actuators 50 cause the boom sections 82 to rotate and/or translate (e.g., telescope) relative to one another to reposition the implement interface 18 relative to the turntable 80.

### Implement Stabilization

Referring to FIGS. 2-6, the lift device 10 includes a stabilizer assembly, shown as gyroscope assembly 100. The gyroscope assembly 100 is configured to counteract or otherwise mitigate movements of the implement assembly 16 associated with an operation of the lift device 10 to stabilize the implement assembly 16 (e.g., the implement 60) relative to the lift device 10 and the ground surface. By way of example, the gyroscope assembly 100 is configured to counteract or otherwise mitigate movement of the implement assembly 16 such as movement caused by manipulators moving an object, tools performing a task, operators or robot arms moving around on a work platform, uneven loading on the implement 60, reaction forces from interactions with a work piece, movement of the boom sections 82 or the turntable 80, driving the lift device 10, movement caused by environmental factors (e.g., wind), etc.

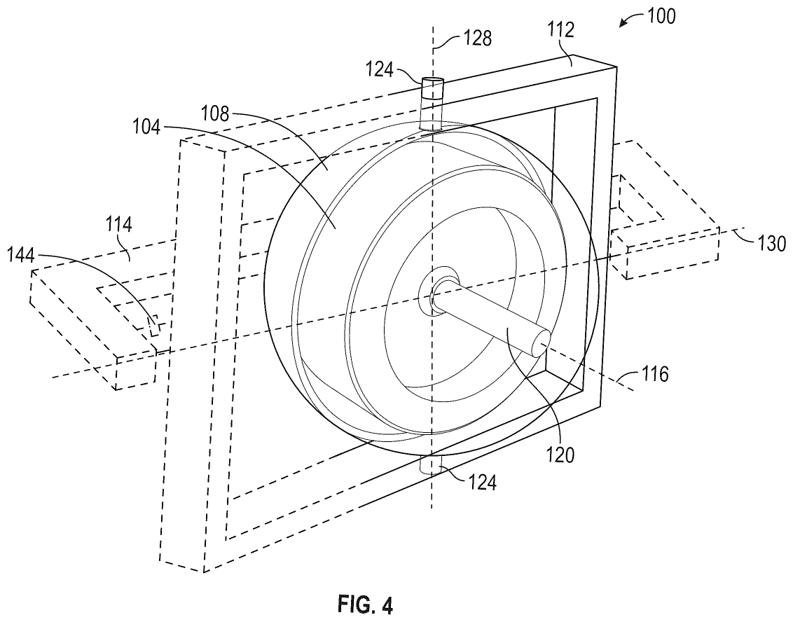

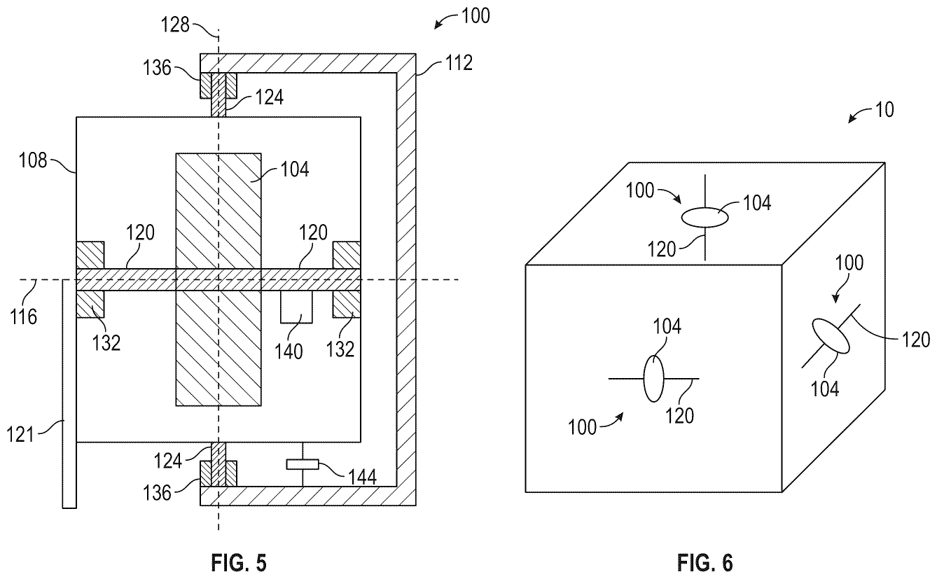

As shown in FIGS. 4 and 5, the gyroscope assembly 100 includes a gyroscope, shown as flywheel 104, an enclosure (e.g., a chamber), shown as housing 108, configured to receive the flywheel 104, and a frame member (e.g., a support member), shown as frame 112, coupled with the housing 108 and configured to support the housing 108. The flywheel 104 defines a generally circular shape and is rotatable about an axis of rotation, shown as flywheel axis 116. In some embodiments, the flywheel 104 is otherwise suitably shaped (e.g., conical, cylindrical, etc.). As shown in FIGS. 4 and 5, the flywheel 104 includes a shaft, shown as flywheel shaft 120, extending from the flywheel 104 along the flywheel axis 116. The flywheel shaft 120 extends from opposing surfaces of the flywheel 104 along the flywheel axis 116. In some embodiments, the flywheel 104 and the flywheel shaft 120 are integrally formed as a unitary body. In other embodiments, the flywheel shaft 120 and the flywheel 104 are two or more sections configured to be coupled together.

As shown in FIGS. 4 and 5, the flywheel 104 and the flywheel shaft 120 are configured to rotatably couple with the housing 108 (e.g., at each end of the flywheel shaft 120) within an interior chamber thereof (e.g., such that the flywheel 104 and the flywheel shaft 120 can rotate about the flywheel axis 116 within the housing 108). In some embodiments, at least a portion of the flywheel shaft 120 extends outside of the interior chamber of the housing 108. As shown in FIG. 4, the housing 108 defines a generally spherical shape. In some embodiments, the housing 108 is otherwise suitably shaped (e.g., conical, cylindrical, cuboidal, etc.) to permit rotation of the flywheel 104 and the flywheel shaft 120 within the housing 108. In some embodiments, the housing 108 is vacuum sealed to increase a velocity at which the flywheel 104 can rotate (e.g., with the same power output from the motor 140). As shown in FIGS. 4 and 5, the housing 108 includes a shaft, shown as housing shaft 124, defining an axis of rotation, shown as housing axis 128, about which the housing 108 and the housing shaft 124 are configured to rotate. The housing shaft 124 extends from opposing ends of the housing 108. In some embodiments, the housing 108 and the housing shaft 124 are integrally formed as a unitary body. In other embodiments, the housing 108 and the housing shaft 124 are two or more sections configured to be coupled together. As shown in FIGS. 4 and 5, the flywheel axis 116 and the housing axis 128 are substantially perpendicular to each other (e.g., within 5% of perpendicular). As shown in FIG. 5, the gyroscope assembly 100 includes bearings 132 configured to rotatably couple the flywheel shaft 120 (and the flywheel 104) to the housing 108.

As shown in FIGS. 4 and 5, the frame 112 includes one or more straight or bent sections configured to couple with the housing 108 at the housing shafts 124 positioned on opposing sides to the housing 108. The frame 112 is configured to facilitate coupling the gyroscope assembly 100 to the implement assembly 16 (e.g., to the implement 60). As shown in FIG. 5, the gyroscope assembly 100 includes bearings 136 configured to rotatably couple the housing shaft 124 (and the housing 108) to the frame 112.

As shown in FIG. 5, the gyroscope assembly 100 includes a flywheel mover, shown as motor 140. The motor 140 is coupled with the flywheel 104 and/or the flywheel shaft 120 and configured to rotate the flywheel 104 and the flywheel shaft 120 about the flywheel axis 116. The motor 140 may be an electric motor and/or an internal combustion engine that receives stored energy and provides rotational mechanical energy to the flywheel 104 and/or the flywheel shaft 120. The motor 140 may be positioned within the housing 108 to provide rotational energy to the flywheel 104 and/or the flywheel shaft 120. In some embodiments, the motor 140 is positioned outside of the housing 108. The motor 140 may be communicably coupled with the base controller 40 and/or the implement controller 70 such that operation of the motor 140 (e.g., a power output, a output rate of rotation, etc.) is controlled thereby. In some embodiments, rotational mechanical energy is otherwise provided to the flywheel 104 and/or the flywheel shaft 120 without the motor 140 (e.g., using the prime mover 24).

During operation of the gyroscope assembly 100 (e.g., when the motor 140 rotates the flywheel 104), the angular momentum of the flywheel 104 vector is perpendicular to a plane of rotation. When an external torque is applied to the flywheel 104 (e.g., a force due to movement of the implement 60 as discussed in greater detail above), the flywheel 104 moves (e.g., precesses) at a right angle to the direction (e.g., in an opposite direction) of the external torque, and thereby resists a change to its orientation due to the conservation of momentum. In other words, responsive to an applied force on the flywheel 104 (e.g., when the flywheel 104 is rotating), the flywheel 104 induces a reaction force (e.g., a reaction torque) to counteract (e.g., oppose) the applied force and resist a change to its orientation. In some embodiments, the gyroscope assembly 100 is a passive gyroscope assembly such that the flywheel 104 rotates without a controlled torque induced precession. In other embodiments, the gyroscope assembly 100 is an active gyroscope assembly such that the flywheel 104 rotates with a controlled torque induced precession. In such embodiments, the gyroscope assembly 100 may include one or more actuators (e.g., electric actuators, pneumatic actuators, hydraulic actuators, etc.) shown as actuators 121 configured to apply a force to the flywheel 104 (e.g., indirectly to the flywheel 104 through the frame 112 and/or the housing 108), which causes the flywheel 104 to induce a reaction force (e.g., a reaction torque) to counteract (e.g., oppose) the applied force. By way of example, responsive to a detection of movement of the implement 60 (e.g., via one or more sensors), the one or more actuators 121 apply a force to the flywheel 104 to cause the flywheel 104 to induce a reaction force that counteracts the applied force, thereby mitigating the movement of the implement 60.

As shown in FIG. 5, the gyroscope assembly 100 further includes an engagement mechanism, shown as clutch 144, coupled to and positioned between the frame 112 and the housing 108. The clutch 144 may be an electric clutch, a pneumatic clutch, or a hydraulic clutch. The clutch 144 is configured to selectively engage (e.g., mechanically link) the frame 112 and the housing 108 with each other. When the clutch 144 is engaged to mechanically fix the frame 112 and the housing 108 with each other, rotation of the housing 108 relative to the frame 112 (e.g., rotation facilitated by the bearings 136) is inhibited. In this manner, when the clutch 144 is engaged, a reaction force generated from the flywheel 104 responsive to the applied force can be transferred (e.g., applied, etc.) from the housing 108 to the frame 112 such that the frame 112 experiences the reaction force (e.g., a force to oppose the movement of the implement 60). Similarly, when the clutch 144 is disengaged, rotation of the housing 108 relative to the frame 112 (e.g., rotation facilitated by the bearings 136) is permitted. In this manner, when the clutch 144 is disengaged, a reaction force generated from the flywheel 104 responsive to the applied force is not transferred from the housing 108 to the frame 112 such that the frame 112 does not experience the reaction force. Accordingly, transitioning the clutch 144 between the engaged configuration and the disengaged configuration facilitates (i) transferring the reaction forces (e.g., precession forces) from the gyroscope assembly 100 to the implement 60 to stabilize the implement 60 and (ii) isolating the reaction forces (e.g., precession forces) within the gyroscope assembly 100 to permit free movement of the implement 60 (e.g., advantageous in certain operational scenarios where stabilization is unnecessary or undesirable), respectively. By way of example, the clutch 144 may be engaged when it is desired to stabilize the implement 60 (e.g., at a desired position, orientation, etc.), and the clutch 144 may be disengaged during intentional or desired movement of the implement 60. In other words, a magnitude of the movement of the implement 60 associated with an operation thereof when the clutch 144 is engaged (e.g., to substantially stabilize the implement 60 at a desired orientation, to reduce a perceptibility of oscillations caused by movement of the implement 60, etc.) is less than a magnitude of the movement of the implement 60 associated with an operation thereof when the clutch 144 is disengaged. The clutch 144 may be communicably coupled with the base controller 40 and/or the implement controller 70 such that operation of the clutch 144 (e.g., engaging or disengaging the frame 112 and the housing 108 with each other) is controlled thereby.

In some embodiments, in addition or as an alternative to engaging and disengaging the clutch 144 during certain operational scenarios (to selectively stabilize or permit movement of the implement 60), the flywheel 104 may be selectively rotated or stopped from rotating. By way of example, when the implement 60 is in a desired position and a desired orientation, the flywheel 104 may begin rotating (e.g., via the motor 140) to stabilize the implement 60 at the desired position and the desired orientation. By way of another example, the gyroscope assembly 100 may include a braking system configured to sufficiently slow or stop rotation of the flywheel 104 such that movement of the implement 60 is not inhibited by the gyroscope assembly 100 (e.g., such that reaction forces generated by the gyroscope assembly 100 are not experienced by the implement 60).

In some embodiments, the gyroscope assembly 100 includes is a secondary frame, shown as second frame 114, that is rotatably coupled with the frame 112 to allow for the frame 112 (and thus the housing 108) to rotate about a third axis, shown as frame axis 130, perpendicular to both the flywheel axis 116 and the housing axis 128. In such embodiments, the frame 112 may extend around the housing 108 to provide a location along the frame 112 for the second frame 114 to couple thereto. In some embodiments, there is additionally a second clutch, similar to the clutch 144, coupled to and positioned between the frame 112 and the second frame 114. The second clutch is similarly configured to selectively mechanically fix the frame 112 to the second frame 112 to allow for selective transferring and isolating of reaction forces from the gyroscope assembly 100 to the implement 60 about the frame axis 130. In some embodiments, the gyroscope assembly 100 omits the second frame 114, and the frame 112 is rotatably coupled with the implement 60.

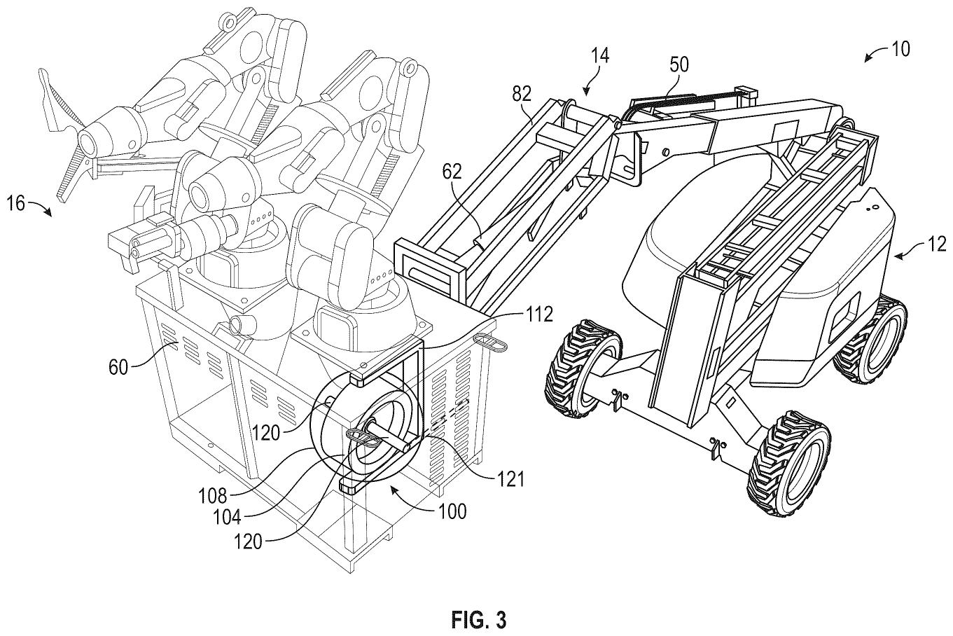

As shown in FIGS. 2 and 3, the frame 112 is configured to couple the gyroscope assembly 100 to the implement assembly 16. The frame 112 may be fixedly coupled to the implement assembly 16, or a component thereof such as the implement 60, such that relative movement between (i) the frame 112 and the implement assembly 16 is inhibited, (ii) the housing 108 and the implement assembly 16 is selectively inhibited (e.g., using the clutch 144), and (iii) the flywheel 104 and the implement assembly 16 is permitted. In some embodiments, the gyroscope assembly 100 does not include the frame 112. In such embodiments, the implement 60 may be configured to couple with the housing 108 at the housing shaft 124, and the bearings 136 may facilitate rotatably coupling the housing shaft 124 to the implement 60. Further, in such embodiments, the clutch 144 may be positioned between the housing 108 and the implement 60 and may be configured to selectively engage (e.g., mechanically link) the implement 60 and the housing 108 with each other. As shown in FIG. 3, the gyroscope assembly 100 is coupled to the implement assembly 16 such that the gyroscope assembly 100 is substantially centered (e.g., laterally centered, longitudinally centered, vertically centered) along the implement 60. By way of example, as shown in FIG. 3, the housing axis 128 may be substantially perpendicular to a horizontal plane (e.g., the ground surface) and the flywheel axis 116 may be substantially parallel with the horizontal plane and extend in a lateral direction between left and right sides of the implement 60, for example (e.g., when the gyroscope assembly 100 is at equilibrium). In some embodiments, the gyroscope assembly 100 is otherwise oriented (e.g., the housing axis 128 and the flywheel axis 116 are otherwise oriented). The gyroscope assembly 100 is coupled to the implement assembly 16 and configured to mitigate the movements experienced by (e.g., stabilize) the implement 60 (e.g., to reduce a perceptibility of oscillations caused by movement of the implement 60). The gyroscope assembly 100 may be oriented such that the reaction force generated from the flywheel 104 responsive to the movement of the implement 60 is transferred to the implement 60 (e.g., when the clutch 144 is engaged) to oppose the movement of the implement 60. In some embodiments, the gyroscope assembly 100 includes one flywheel 104 configured to induce an asymmetric load to stabilize the implement 60. In other embodiments, the gyroscope assembly 100 is a dual gyroscopic stabilizer including two flywheels 104 configured to rotate in opposite directions and coupled together by a gear assembly such that precession of one flywheel 104 causes precession in the second flywheel 104 in an opposite direction. In such embodiments, the gyroscope assembly 100 induces a symmetric load to stabilize the implement 60.

As shown in FIG. 6, the gyroscope assembly 100 may be oriented to oppose lateral, longitudinal, and/or vertical movement of the implement 60. That is, depending on the orientation of the flywheel axis 116, the implement 60 is stabilized in a corresponding degree of freedom. By way of example, the flywheel axis 116 oriented in a lateral direction may limit movement of the implement 60 in the lateral direction, the flywheel axis 116 oriented in a longitudinal direction may limit movement of the implement 60 in the longitudinal direction, and the flywheel axis 116 oriented in a vertical direction may limit movement of the implement 60 in the vertical direction. In some embodiments, the gyroscope assembly 100 is oriented to limit movement that is the most severe in a particular direction for a particular application of the lift device 10 (e.g., a first horizontal direction for solar installation, a second horizontal direction for hammering applications, a vertical direction for painting, blasting, or washing, etc.). As shown in FIG. 6, in some embodiments, the lift device 10 includes one or more gyroscope assemblies 100 variously positioned about and coupled to the implement assembly 16 to limit movement thereof. By way of example, the lift device 10 may include three gyroscope assemblies 100 each having the different orientations, such that a first gyroscope assembly 100 is oriented to limit movement of the implement 60 in a first direction, a second gyroscope assembly 100 is oriented to limit movement of the implement 60 in a second direction, and a third gyroscope assembly 100 is oriented to limit movement of the implement 60 in a third direction. In some embodiments, one or two of the three gyroscope assemblies 100 is omitted.

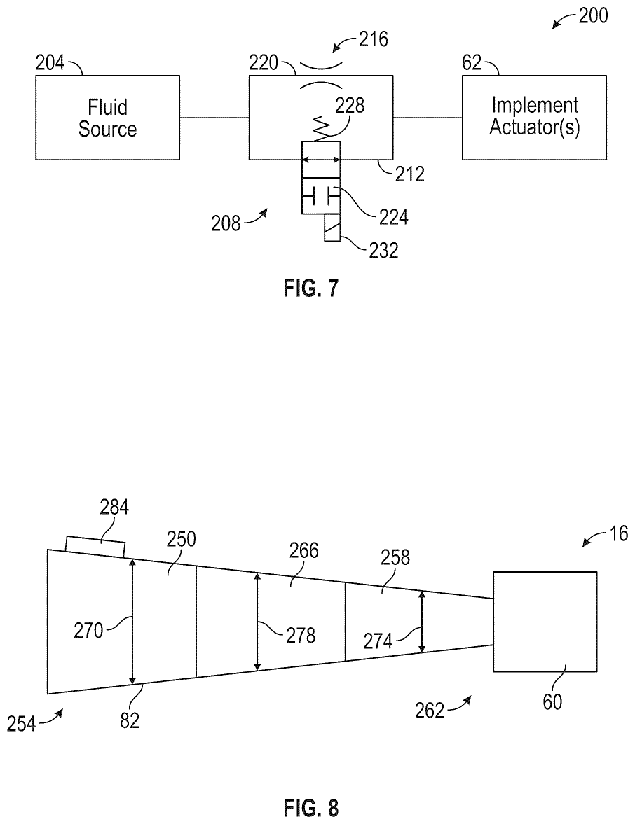

As shown in FIG. 7, the lift device 10 includes an implement stabilization system, shown as hydraulic stabilization system 200, configured to facilitate stabilizing the implement 60. The hydraulic stabilization system 200 includes a fluid supply, shown as fluid source 204, one or more of the implement actuators 62, a hydraulic fluid valve assembly, shown as valve assembly 208, fluidly coupled between the fluid source 204 and the implement actuator 62 along a fluid supply line (e.g., conduit, hose, pipe, tube, etc.), shown as first supply line 212, and a fluid passage, shown as orifice 216, fluidly coupled between the fluid source 204 and the implement actuator 62 along a fluid supply line (e.g., conduit, hose, pipe, tube, etc.), shown as second supply line 220.

The fluid source 204 may include a pump (e.g., the pump 30) and/or a compressor (e.g., the compressor 32). The pump may receive rotational mechanical energy (e.g., from the prime mover 24) and provide a supply of pressurized liquid (e.g., hydraulic oil, water, etc.). The compressors may receive rotational mechanical energy (e.g., from the prime mover 24) and provide a supply of pressurized gas (e.g., air, refrigerant, etc.). The pressurized liquid and/or the pressurized gas may be supplied to the implement actuator 62 and/or various components of the lift device 10 to facilitate operation of the lift device 10. As shown in FIG. 7, the first supply line 212 and the second supply line 220 fluidly couple the fluid source 204 with the implement actuator 62, and facilitate suppling and/or returning fluid (e.g., pressurized liquid, pressurized gas, etc.) between the fluid source 204 with the implement actuator 62.

As shown in FIG. 7, the valve assembly 208 includes a valve body, shown as valve 224, a biasing element, shown as spring 228, and an actuator, shown as solenoid 232. The valve assembly 208 is positioned along the first supply line 212. The valve assembly 208 is fluidly coupled with the first supply line 212 to selectively permit or inhibit a flow of the fluid between the fluid source 204 and the implement actuator 62. In a default state (e.g., when the solenoid 232 is not activated, a normal state, an operating state, etc.), the valve 224 is biased by the spring 228 to an open position to permit the flow of fluid between the fluid source 204 and the implement actuator 62. By way of example, a spring force exerted on the valve 224 by the spring 228 may bias the valve 224 such that the valve 224 substantially permits (e.g., does not block, restrict, or inhibit, etc.) the flow, such that an opening of the valve 224 is positioned in line with the first supply line 212 and fluid can flow therethrough, or otherwise bias the valve 224 to the open position. As shown in FIG. 7, the solenoid 232 is operably coupled with the valve 224 and configured to selectively transition the valve 224 between the open position and a closed position. By way of example, the solenoid 232 may be activated (e.g., responsive to receiving a signal from the base controller 40 and/or the implement controller 70) to engage with the valve 224 to transition the valve 224 between the open position and the closed position (e.g., overcome the spring force to transition the valve 224 from the open position to the closed position). In the closed position, the valve 224 is positioned such that the flow of fluid between the fluid source 204 and the implement actuator 62 is inhibited (e.g., blocked, restricted, to fluidly decouple the fluid source 204 and the implement actuator 62 from each other, etc.) via the first supply line 212. When the solenoid 232 is deactivated or otherwise disengaged from the valve 224, the valve 224 is biased to return to the open position. In some embodiments, the valve 224 is otherwise transitioned between the open position and the closed position (e.g., hydraulically actuated, pneumatically actuated, etc.). In some embodiments, in a default state, the valve 224 is biased (e.g., spring biased) to the closed position and transitioned to the open position responsive to an activation of the solenoid 232.

As shown in FIG. 7, the orifice 216 is fluidly coupled with the second supply line 220 to restrict (e.g., obstruct) a flow of the fluid between the fluid source 204 and the implement actuator 62. The orifice 216 is fluidly coupled along the second supply line 220 such that fluid flowing between the fluid source 204 and the implement actuator 62 via the second supply line 220 flows through the orifice 216. The orifice 216 defines an inner diameter that is less than an inner diameter of the second supply line 220 (e.g., a cross-sectional area of the orifice 216 is less than a cross-sectional area of the second supply line 220) such that the flow rate of the fluid flowing through the orifice 216 is restricted (e.g., reduced). As a result of the restriction induced by the orifice 216 on the fluid, the fluid will preferentially flow between the fluid source 204 and the implement actuator 62 via the first supply line 212 (e.g., when the valve 224 is in the open position). By way of example, when the valve 224 is in the open position, the flow of fluid is substantially unobstructed within the first supply line 212 and the flow of fluid is obstructed (e.g., by the orifice 216) within the second supply line 220 such that a majority of the fluid flows between the fluid source 204 and the implement actuator 62 via the first supply line 212. When the valve 224 is in the closed position, the flow of fluid between the fluid source 204 and the implement actuator 62 via the first supply line 212 is inhibited such that, instead, the fluid flows (e.g., in a restricted manner with a decreased flow rate than the flow rate of the fluid through the valve 224 in the open position) between the fluid source 204 and the implement actuator 62 through the orifice 216 via the second supply line 220.

The implement actuator 62 is coupled with the implement 60 such that movement of the implement 60, as discussed in greater detail above, causes the implement actuator 62 to compress and transfer fluid therefrom to the fluid source 204. When the valve 224 is in the open position, the valve assembly 208 facilitates substantially unobstructed fluid to flow between the fluid source 204 and the implement actuator 62 (e.g., responsive to movement of the implement 60). Conversely, when the valve 224 is in the closed position, the orifice 216 restricts the flow of fluid between the fluid source 204 and the implement actuator 62 (e.g., responsive to movement of the implement 60). In this manner, responsive to movement of the implement assembly 16 (e.g., and the implement 60), the implement actuator 62 supplies fluid therefrom to the fluid source 204 such that, when the valve 224 is in the closed position, the flow of fluid is directed through the orifice 216 via the second supply line 220 such that movement of the implement assembly 16 is dampened (e.g., to substantially stabilize the implement 60 at a desired orientation, to reduce a perceptibility of oscillations caused by movement of the implement 60, etc.). By way of example, the movements of the implement 60 are dampened such that a magnitude of the movement of the implement 60 associated with an operation thereof when the valve 224 is in the closed position (e.g., when the fluid is forced to flow through the orifice 216) is less than a magnitude of the movement of the implement 60 associated with an operation thereof when the valve 224 is in the open position.

Additionally, in some instances, when the valve 224 is in the closed position and the orifice 216 restricts the flow of fluid between the implement actuator 62 and the fluid source 204, if a sudden impulse is applied to the implement 60 (e.g., via a sudden weight being applied to the implement 60, the operator jumping on the implement 60) while the implement 60 is otherwise stationary (e.g., fluid is not being actively pumped from the fluid source 204 to the implement actuators 62 by one of the pumps 30), the orifice 216 in the second supply line 220 causes undesired fluid flow from the implement actuator 62 back toward the fluid source 204 to be dampened or restricted, thereby further reducing or dampening oscillations felt by the implement 60 (and thus the operator on the implement 60).

As shown in FIG. 8, the boom sections 82 include two or more portions having different materials or different thicknesses (e.g., widths, diameters, etc.). According to an exemplary embodiment, the boom sections 82 include a first boom portion 250 proximate a first end 254 of the boom sections 82, a second boom portion 258 proximate a second end 262 of the boom sections 82 (the first end 254 opposite the second end 262), and a third boom portion 266 extending between the first boom portion 250 and the second boom portion 258. The first boom portion 250 may be configured to couple with the turntable 80 at the base assembly 12 of the lift device 10. In some embodiments, the first boom portion 250 is configured to couple with another boom section 82. As shown in FIG. 8, the second boom portion 258 is configured to couple with the implement assembly 16. In some embodiments, the second boom portion 258 is configured to couple with another boom section 82. In some embodiments, the boom section 82 include more or fewer portions than the first boom portion 250, the second boom portion 258, and the third boom portion 266.

During operation of the lift device 10 and the lift assembly 14, boom sections 82 experience varying loads (e.g., varying stress distributions) along the lengths thereof. By way of example, the first boom portion 250 may experience a greater load (e.g., support more weight, experience greater stress concentrations, etc.) compared to that of the second boom portion 258. Accordingly, the first boom portion 250 may have a stronger material or have a greater thickness to accommodate supporting the greater load experienced thereby (compared to that of the second boom portion 258 and the third boom portion 266). In such an example, the first boom portion 250 may have a material and/or thickness different than that of the second boom portion 258 and/or the third boom portion 266 to account for such varying loads along the length of the boom section 82. Similarly, the second boom portion 258 may have a material and/or thickness different than that of the first boom portion 250 and/or the third boom portion 266 to account for such varying loads along the length of the boom section 82. In some embodiments, the first boom portion 250 is made from a first material or combination of materials (e.g., steel, steel alloy, etc.) having a strength (e.g., a tensile strength, a yield strength, a Young's modulus, etc.) greater than a strength of each of the materials of the second boom portion 258 and the third boom portion 266. In some embodiments, the second boom portion 258 is made from a second material or combination of materials (e.g., aluminum, aluminum alloy, etc.) having a strength (e.g., a tensile strength, a yield strength, a Young's modulus, etc.) less than a strength of each of the materials of the first boom portion 250 and the third boom portion 266. By way of example, the first boom portion 250 may be made from a first material (e.g., steel, steel alloy, etc.), the second boom portion 258 may be made from a second material (e.g., aluminum, aluminum alloy, etc.), and the third boom portion 266 may be made from a third material (e.g., carbon fiber), wherein the first material is stronger than the second material and the third material, and the third material is stronger than the second material. In some embodiments, each of the first boom portion 250, the second boom portion 258, and the third boom portion 266 are made from the same material.

Additionally or alternatively to the varying materials across the length of the boom sections 82, the boom sections 82 may define a varying thickness across the length thereof to account for such varying loads along the length of the boom sections 82. The first boom portion 250 defines a first thickness 270, the second boom portion 258 defines a second thickness 274, and the third boom portion 266 defines a third thickness 278. As shown in FIG. 8, the first thickness 270 is greater than the second thickness 274 and the third thickness 278, and the third thickness 278 is greater than the second thickness 274.

In some embodiments, the thickness of the boom section 82 (e.g., the first thickness 270, the second thickness 274, and/or the third thickness 278) decreases linearly (e.g., tapers) along the length thereof from the first end 254 to the second end 262. In some embodiments, the thickness of the boom section 82 decreases non-linearly (e.g., according to a curvilinear function) along the length thereof. In some embodiments, the thickness of the boom section 82 decreases at different linear rates along different portions (e.g., the first boom portion 250, the second boom portion 258, and the third boom portion 266) of the boom section 82. By way of example, across the first boom portion 250, the first thickness 270 may decrease according to a first linear rate or slope (or according to a curvilinear function), across the second boom portion 258, the second thickness 274 may decrease according to a second linear rate or slope that is different (e.g., greater or less) than the first linear rate or slope, and third boom portion 266, the third thickness 278 may decrease according to a third linear rate or slope that is different (e.g., greater or less) than the second linear rate or slope and/or the first linear rate or slope. The thickness of the boom section 82 may decrease according to any linear or non-linear function, or combination thereof along the first boom portion 250, the second boom portion 258, and the third boom portion 266 in a direction from the first end 254 to the second end 262 along the length of the boom section 82. By way of another example, the first thickness 270 may be substantially constant across the first boom portion 250, the second thickness 274 may be substantially constant across the second boom portion 258, and the third thickness 278 may be substantially constant across the third boom portion 266 such that the thickness of the boom section 82 steps down at the transition between (i) the first boom portion 250 and the third boom portion 266 and (ii) the second boom portion 258 and the third boom portion 266. In some embodiments, the boom sections 82 include more or fewer than three portions. In some embodiments, the thickness of the boom sections 82 is otherwise shaped or dimensioned.

As shown in FIG. 8, the lift device 10 includes a reinforcement member (e.g., a reinforcement beam, collar, panel, etc.), shown as boom support 284, coupled with the boom section 82 at the first boom portion 250. The boom support 284 is configured to couple with the boom section 82 to increase the strength (e.g., rigidity, deformation resistance, etc.) of the boom section 82. In some embodiments, the boom support 284 is positioned at a point or portion along the boom section 82 with relatively high stress concentrations or with a greater susceptibility to failure. In some embodiments, the boom support 284 is removably coupled with the boom section 82. In other embodiments, the boom support 284 extends along an entire portion of an outer periphery of the boom section 82 (e.g., encircles, surrounds, etc.) or extends along a portion of the outer periphery of the boom section 82. In some embodiments, two or more boom support 284 are coupled with the boom section 82 (e.g., at one or more positions along the length of the boom section 82). In some embodiments, the lift device 10 does not include the boom support 284.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 as shown in the various exemplary embodiments is illustrative only. Additionally, any element disclosed in one embodiment may be incorporated or utilized with any other embodiment disclosed herein. For example, the outriggers 36 of the exemplary embodiment shown in at least FIG. 1 may be incorporated in the lift device 10 of the exemplary embodiment shown in at least FIG. 2. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device comprising:
a chassis;
an implement assembly including an implement actuator; and
a lift assembly coupling the implement assembly to the chassis and configured to raise the implement assembly relative to the chassis;
wherein at least one of:
the lift device further comprises a gyroscope assembly coupled with the implement assembly and configured to stabilize the implement assembly, the gyroscope assembly including:
a housing; and
a flywheel rotatably coupled to the housing;
wherein rotation of the flywheel causes the gyroscope assembly to apply a force to the implement assembly to oppose movement of the implement assembly;
the lift device further comprises a hydraulic stabilization system coupled with the implement assembly and configured to stabilize the implement assembly, the hydraulic stabilization system including:
a fluid source fluidly coupled with the implement actuator;
a valve assembly fluidly coupled between the fluid source and the implement actuator along a first supply line, the valve assembly actuatable between (i) an open position to permit a flow of fluid between the fluid source and the implement actuator via the first supply line and (ii) a closed position to inhibit the flow of fluid between the fluid source and the implement actuator via the first supply line; and
an orifice fluidly coupled between the fluid source and the implement actuator along a second supply line, the orifice restricting the flow of fluid therethrough;
wherein, responsive to movement of the implement assembly when the valve is in the closed position, fluid flowing between the implement actuator and the fluid source is directed through the orifice via the second supply line, thereby restricting the flow of fluid and dampening the movement of the implement assembly; or
the lift assembly includes a first boom portion and a second boom portion, wherein a first material or a first thickness of the first boom portion is different than a second material or a second thickness of the second boom portion, respectively, such that the first boom portion is capable of supporting a load greater than a load capable of being supported by the second boom portion.

2. The lift device of claim 1, wherein the lift device includes the gyroscope assembly.

3. The lift device of claim 2, wherein the housing defines an interior chamber, and wherein the flywheel is rotatably coupled to the housing within the interior chamber.

4. The lift device of claim 2, wherein the gyroscope assembly includes at least one frame coupling the housing with the implement assembly.

5. The lift device of claim 4, wherein the housing is rotatably coupled to the at least one frame.

6. The lift device of claim 2, wherein the gyroscope assembly is a passive gyroscope assembly such that the flywheel rotates without a controlled torque induced precession.

7. The lift device of claim 2, wherein the gyroscope assembly is an active gyroscope assembly and includes an actuator configured to apply a force to the flywheel such that the flywheel rotates with a controlled torque induced precession.

8. The lift device of claim 2, wherein the gyroscope assembly includes a clutch that is transitionable between an engaged state and a disengaged state to selectively couple the housing with the implement assembly.

9. The lift device of claim 8, wherein, in the engaged state, the clutch couples the housing with the implement assembly such that the implement assembly experiences the force from the gyroscope assembly to oppose movement of the implement assembly, and wherein, in the disengaged state, the clutch decouples the housing from the implement assembly such that the implement assembly does not experience the force from the gyroscope assembly.

10. The lift device of claim 2, wherein the gyroscope assembly includes a motor to provide rotational energy to the flywheel.

11. The lift device of claim 2, wherein the gyroscope assembly is centered along the implement assembly.

12. The lift device of claim 2, wherein the gyroscope assembly is a first gyroscope assembly configured to apply the force to the implement assembly in a first direction, and wherein the lift device further comprises a second gyroscope assembly configured to apply the force to the implement assembly in a second direction different than the first direction.

13. The lift device of claim 1, wherein the lift device includes the hydraulic stabilization system.

14. The lift device of claim 13, wherein the valve assembly includes a valve and a spring coupled with the valve to bias the valve toward the open position.

15. The lift device of claim 14, wherein the valve assembly includes a solenoid operatively coupled with the valve to selectively transition the valve between the open position and the closed position.

16. The lift device of claim 1, wherein the lift assembly includes the first boom portion and the second boom portion.

17. The lift device of claim 16, wherein the lift assembly includes a reinforcement member coupled to at least one of the first boom portion or the second boom portion and configured to increase a strength of the at least one of the first boom portion or the second boom portion.

18. The lift device of claim 1, wherein the lift device includes the gyroscope assembly, the hydraulic stabilization system, the first boom portion, and the second boom portion.

19. A lift device comprising:
a chassis;
an implement assembly;
a lift assembly coupling the implement assembly to the chassis and configured to raise the implement assembly relative to the chassis; and
a gyroscope assembly coupled with the implement assembly and configured to stabilize the implement assembly, the gyroscope assembly including:
a housing defining an interior chamber;
a flywheel rotatably coupled to the housing within the interior chamber; and
at least one frame coupling the housing with the implement assembly;
wherein rotation of the flywheel causes the gyroscope assembly to apply a force to the implement assembly to oppose movement of the implement assembly.

20. A lift device comprising:
a chassis;
an implement assembly;
a lift assembly coupling the implement assembly to the chassis and configured to raise the implement assembly relative to the chassis; and
a gyroscope assembly coupled with and centered along the implement assembly and configured to stabilize the implement assembly, the gyroscope assembly including:
a housing;
a flywheel rotatably coupled to the housing; and
a clutch that is transitionable between an engaged state and a disengaged state;
wherein the housing is coupled with at least one of a frame coupled with the implement assembly or the implement assembly;
wherein rotation of the flywheel causes the gyroscope assembly to apply a force to the implement assembly to oppose movement of the implement assembly; and
wherein, in the engaged state, the clutch couples the housing with at least one of the frame or the implement assembly such that the implement assembly experiences the force from the gyroscope assembly to oppose movement of the implement assembly, and wherein, in the disengaged state, the clutch decouples the housing from the frame and the implement assembly such that the housing can rotate relative to the frame and the implement assembly and the implement assembly does not experience the force from the gyroscope assembly.
